(19) United States
(12) Patent Application Publication
(10) Pub. No.: US 2012/0260487 A1
(43) Pub. Date: Oct. 18, 2012

(54) REPLACEABLE BOTTLE CAP ASSEMBLY

(76) Inventor: Patrick Myron Nichols, Malone, NY (US)

(21) Appl. No.: 13/532,275

(22) Filed: Jun. 25, 2012

Related U.S. Application Data
(63) Continuation-in-part of application No. 12/360,561, filed on Jan. 27, 2009, now abandoned.
(60) Provisional application No. 61/131,575, filed on Jun. 10, 2008.
(60) Provisional application No. 61/062,804, filed on Jan. 28, 2008.

(51) Int. Cl. B65D 51/18; B23P 17/00; B23P 11/00; B65D 41/04

(52) U.S. Cl. 29/456; 215/329; 215/306; 215/243; 215/228; 29/592

(57) ABSTRACT

A replaceable bottle cap assembly includes a body that conforms to the top of a threaded beverage container, the assembly including an internally threaded portion that mates with the threaded neck of the beverage container. A set of adapters are releasably and interchangeably used in connection with the body, each adapter being releasably attached to the body and having a threaded portion for engaging the threaded neck portion of a beverage container. A hinged cap of the assembly provides selective access to the contents of the attached beverage container wherein the assembly is sealingly and releasably attached to the container.

### CROSS REFERENCE TO RELATED APPLICATIONS

This patent application is a continuation in part (CIP) application of U.S. Ser. No. 12/360,561, entitled: REPLACEABLE BOTTLE CAP ASSEMBLY, filed Jan. 27, 2009, which claims priority to the following provisional patent applications entitled: REPLACEABLE BOTTLE CAP ASSEMBLY, U.S. Ser. No. 61/131,575, filed Jun. 10, 2008, and BEVERAGE BOTTLE REPLACEMENT CAP WITH HANDLE, DRINKING AND HOLDING DEVICE, U.S. Ser. No. 61/062,804, filed on Jan. 28, 2008, the entire contents of each above noted document being herein incorporated by reference.

### TECHNICAL FIELD

The invention relates to the field of beverage containers and in particular to a replaceable bottle cap assembly that can be used in conjunction with screw-on or threaded beverage containers, such as water, fruit juice and soda bottles.

### BACKGROUND

Beverage containers, including those for bottled soda, bottled water, energy drinks and fruit juices, among others, have been commonly known to consumers for many years. Most of these containers include a threaded cap that is threadingly secured to the upper necked portion of an appropriately sized bottle (e.g., 12 oz, 20 oz, 32 oz, etc.). In order to access the contents of the bottle for consumption, the threaded cap must first be twisted free and then removed. Typically, the entire contents of the bottle are not consumed all at once. Therefore, it later becomes necessary to reattach the cap to the bottle by twisting the cap back onto the threaded neck of the bottle in order to avoid spillage of the remaining fluid contents and having the contents go flat as in the case of carbonated fluids, such as soda.

The foregoing arrangement is not always convenient because it requires the use of both hands wherein one hand of the consumer is required to hold the bottle for stability while the other hand is being used to periodically twist open and/or replace the cap. When the consumer is traveling by vehicle (e.g., car, truck or boat), operating equipment, or otherwise conducting various activities, the removal or reattachment of a screw on/off cap could be hazardous to the consumer and/or others. Another relevant issue is that of having to locate or re-locate the cap once it has been removed from the bottle. In each above-noted instance, the consumer's attention is otherwise directed from the immediate task (e.g., driving, etc.) at hand and potential safety concerns and their consequences may occur. Therefore, it is a general desire to provide an alternative, safer and more convenient means for accessing and extracting the fluid contents from threaded beverage containers.

### SUMMARY OF THE DISCLOSURE

to one version, there is provided a replaceable bottle cap assembly for use with a threaded beverage container, the cap assembly comprising a body shaped to substantially conform with the top of a beverage container, the body having a threaded portion; at least one adapter having a first threaded portion adapted for engaging the threaded neck of a beverage container and a second threaded portion that is releasably attachable to the threaded portion of said body, said at least one adapter including a spout portion; and a snap-fitting cap attached to said body, the cap being releasably attachable to the body to expose said spout portion and in order to selectively access the contents of a beverage container to which the cap assembly is attached.

According to one version, the body includes a skirting portion that is shaped to conform with a curved top of a beverage container.

According to at least one version of the replaceable cap assembly, retaining means for retaining said cap when said cap is in an open position are provided. In at least one embodiment, a hinge assembly attaches said cap to said body, said hinge assembly including a hinge bracket formed on said body that receives a hinge portion of said cap and having a hinge pin extending therethrough. In this version, said retaining means includes a detent for engaging said body when said cap is in said open position.

At least a portion of the body is made from a soft grippable material. In another version, at least a portion of said skirting portion is made from a soft grippable material.

In a preferred version, a handle portion is preferably provided enabling a beverage container to which said assembly is attached to be picked up by a user without contacting said beverage container. In a preferred version, the handle portion is integral to said body.

According to at least one version, an engagement section is formed in an upper portion of said body, said engagement portion including said threaded portion for receiving said adapter.

According to at least one version of the herein described cap assembly, the spout portion of the adapter includes a bottom surface that engages the top surface of a beverage container when said adapter is fully engaged therewith.

According to another aspect, there is provided a method for manufacturing a replaceable cap assembly that is adapted for use with at least two beverage containers having different threaded necked portions, said method comprising the steps of:
providing a set of adapters, each adapter having a different interior threaded engagement portion that can be releasably attached to the threaded neck of a different beverage container;
providing a body, said body including a through opening including an engagement portion for releasably and interchangeably receiving each of said adapters wherein said adapter includes an exterior threaded portion for engaging an interior threaded portion of said body to releasably retain a said adapter; and
providing a releasable snap-fitting cap for selectively covering said through opening, thereby enabling the contents of a beverage container to be accessed for consumption.

In one version, the method can include the step of providing means for retaining said snap-fitting cap on said body when said cap is not covering said threaded portion. A handle portion can be provided in relation to said body to enable said cap assembly and an attached beverage container to be lifted.

According to yet another aspect, there is provided a method of using a releasable cap assembly for a beverage container, said beverage container including a threaded neck portion that receives a cap replaced by said assembly, said method comprising the steps of:
attaching an adapter to the necked threaded portion of a beverage container, said adapter having a through opening having an internal thread over a portion thereof that corresponds to a set of external necked threads of said beverage container, said adapter further including an external threaded portion;
providing a body that conforms to a curved top of said beverage container, said body including a through opening having an internal threaded section and a handle portion; and
attaching the external threads of said adapter to the internal threads of said body such that a portion of said adapter extends outwardly from said opening and forms a spout.

According to one version, the method includes the additional step of opening a cap hingably attached to said body to access the contents of said beverage container when said cap after said assembly has been attached thereto.

The body includes an upper engagement portion having said internal threaded section and in which said adapter further includes a spout that extends above said body when said adapter is attached thereto.

In a preferred version, a first adapter is provided that includes an internal thread configured to engage a first beverage container as well as a second adapter that is configured to threadingly engage a second beverage container in which each of the internal threads are different, said method including the additional steps of selecting an adapter based on the beverage container to which the assembly is to be attached.

One advantage provided by the herein described replaceable cap assembly is ease of use as opposed to the twist off cap of conventional threaded beverage bottles that require removal for each use. There is no longer a need to retain the original bottle cap and therefore having to be concerned about its whereabouts. The assembly provides an effective fluidic seal and therefore maintains all of the functionality provided by twist-off caps, but with considerably less effort. Another advantage is that the herein described assembly can be cleaned and is reusable. Yet another advantage is that the herein described cap assembly can be adaptively attached to any sized beverage container and to any thread design.

These and other features and advantages will be readily apparent from the following Detailed Description, which should be read in conjunction with the accompanying drawings.

### BRIEF DESCRIPTION OF THE DRAWINGS

FIG. 1 is a side view of a replaceable bottle cap assembly in accordance with an exemplary embodiment of the present invention;

FIG. 2 is a front view of the replaceable bottle cap assembly of FIG. 1;

FIG. 3 is a top plan view of the replaceable bottle cap assembly of FIGS. 1 and 2;

FIG. 4 is an exploded assembly view of the replaceable bottle cap assembly in conjunction with a beverage container;

FIG. 4(a) is a side perspective view of the exploded releasable cap assembly of FIG. 4, shown in section;

FIG. 5 is a bottom perspective view of the replaceable bottle cap assembly of FIGS. 1-3 with the cap in the closed position;

FIG. 6 is a bottom perspective view of the replaceable bottle cap assembly, shown as exploded;

FIG. 7 is a side elevational view of the replaceable bottle cap assembly of FIGS. 1-6 as attached to a beverage container, the view being taken in section and in which the cap is shown in a closed position;

FIG. 8 is the side elevational view of FIG. 7 taken in section, wherein the cap is shown in an opened position;

FIG. 9 is a front view taken in elevation of the replaceable bottle cap assembly as attached to a beverage container;

FIG. 10 is a side view taken in elevation of the replaceable bottle cap assembly as attached to a beverage container;

FIG. 11 is a top plan view of the assembly of FIGS. 9 and 10;

FIG. 12 is a front perspective view of the assembly of FIGS. 9-11;

FIG. 13 is the front perspective view of the assembly of FIGS. 9-11 with the cap in the opened position;

FIGS. 14(a)-14(c) depict perspective views of variations of the replaceable bottle cap assembly of FIG. 1-6 in an assembled condition relative to a beverage container;

FIG. 15 is an assembly view of a replaceable bottle cap assembly in accordance with another exemplary embodiment;

FIG. 16 is a front perspective view of the replaceable bottle cap assembly of FIG. 15;

FIG. 17 is an exploded view of the replaceable bottle cap assembly of FIGS. 15 and 16;

FIGS. 18(a) and 18(b) are perspective views of the replaceable bottle cap assembly of FIGS. 15-17 as attached to a threaded bottle container with the hinged cap open and closed, respectively; and

FIG. 19 is a side elevational view, shown partially in section, of the replaceable bottle cap assembly shown in FIG. 18(b).

### DETAILED DESCRIPTION

The following description relates to certain exemplary embodiments of a replaceable bottle cap assembly, shown independently as well as in conjunction with a threaded beverage container (e.g., a 12, 16 or 20 ounce soda, water or other beverage bottle). Throughout the course of discussion, certain terms are used in order to provide a suitable frame of reference with the accompanying drawings such as “top”, “front, “rear”, “bottom”, “upper”, “lower”, “inner”, “outer”, “above”, below”, and the like. These terms are not intended to be overly limiting, however, except where so specifically indicated. Moreover, it will be appreciated that variations and modifications are possible within the intended scope of the present invention wherein the herein described bottle cap assembly and beverage container that is used therewith are intended to be merely exemplary for description purposes

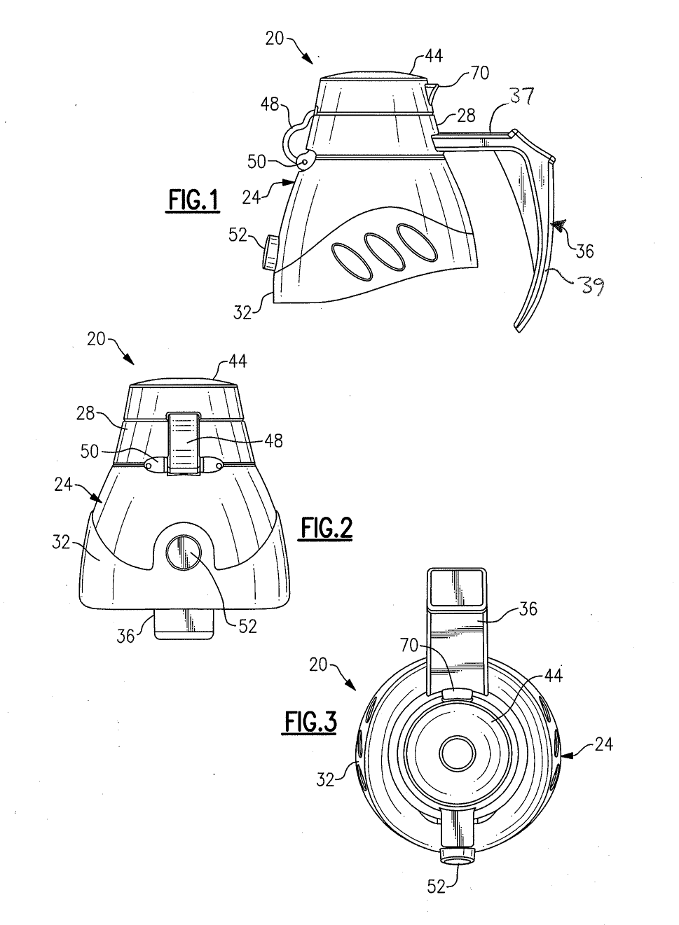

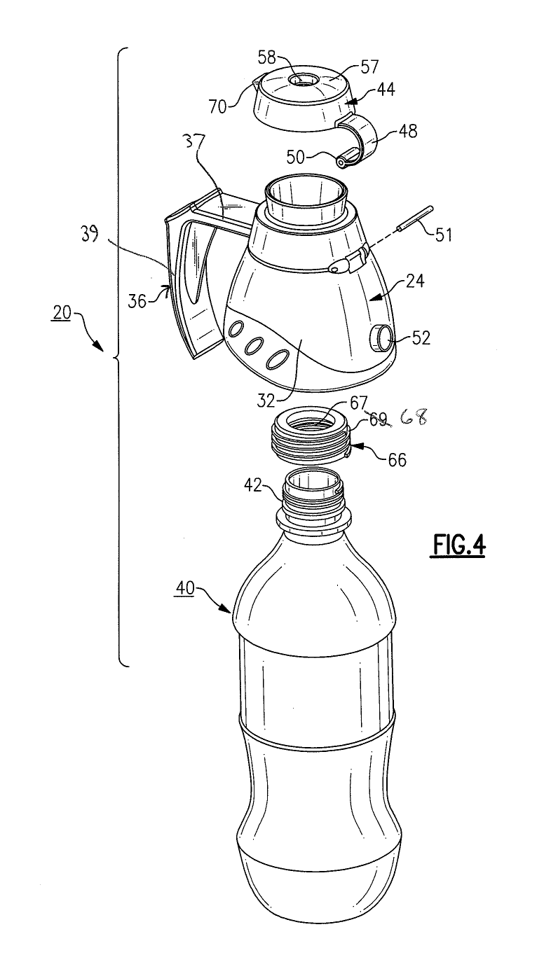

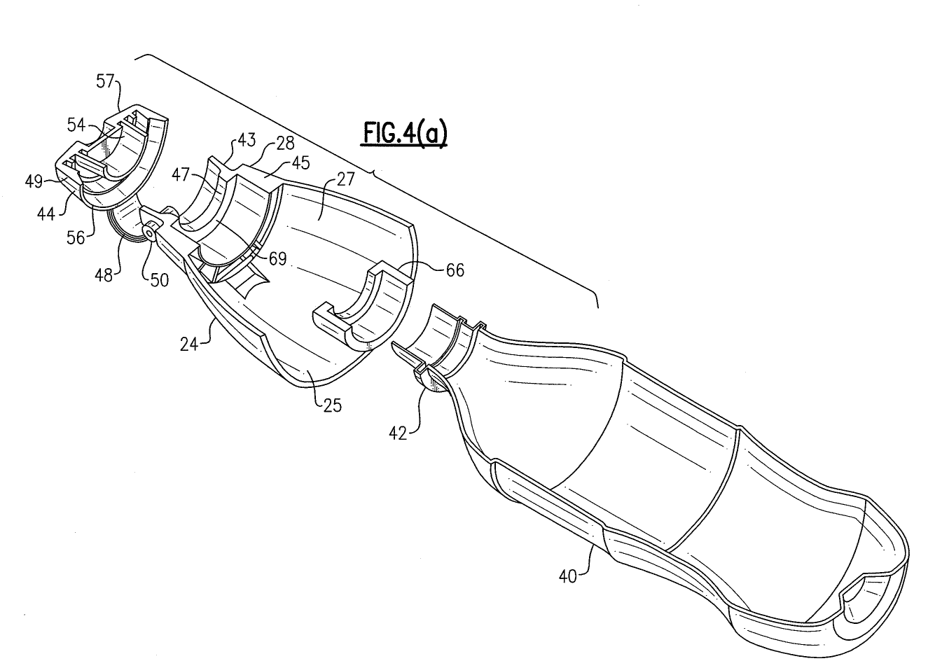

Referring to the figures and more specifically to FIGS. 1-3, there is shown a replaceable bottle cap assembly in accordance with a first exemplary embodiment, wherein this assembly is herein generally labeled with the reference numeral 20. The assembly 20 is defined by two interconnected components; namely, a body 24 and a cap 44. The body 24 according to this exemplary embodiment is made from a durable, lightweight elastomeric material, and can be manufactured using, for example, a blow-molding or injection molding process. A skirting portion 32 is defined at the lower end of the body 24, which is further defined by a generally hemispherical configuration, while an engagement portion 28 is provided at the upper end of the body. As shown in greater detail in FIGS. 4, 4(a), and FIGS. 5-8, the body 24 is substantially hollow, with the exception of the engagement portion 28, including an open lower opening 25 extending to an interior cavity 27 that is shaped to substantially conform with the curved top or upper end of a beverage container, herein shown as 40. Due to the conforming curvature of the body 24, the interior cavity 27 narrows in diameter away from the open lower opening 25. Referring most particularly to FIGS. 4(a), 6 and 7, the engagement portion 28 is provided above the skirting section 32, the engagement portion according to this embodiment being defined by an upper engagement end or spout 43 that permits releasable engagement of the cap 44, described in greater detail below, and a lower engagement end 45 that enables releasable attachment of the assembly 20 with the threaded neck 42 of the bottle 40. The engagement portion 28 is further defined by a through opening 47 having a first diameter in the upper engagement end 43 and a narrower second diameter in the lower engagement end 45. An annular flange 69 divides the upper and lower engagement ends 43, 45, wherein the through opening 47 is of reduced diameter than either the upper or lower engagement ends and forms a throat therebetween. According to the present embodiment, the engagement portion 28 is integrally formed with the remainder of the body 24, such as through mold fabrication, although these components could also be separately manufactured and assembled such as described herein in a later embodiment.

Completing the description of the body 24 and referring again to FIGS. 1-3, an integral handle portion 36 is attached to the exterior of the engagement portion 28 of the body 24, the handle portion extending outwardly from a rear side of the assembly 20 according to this herein described embodiment. According to this embodiment, the handle portion 36 is defined by a web 37 that extends outwardly from the body 24 and a vertically extending grippable portion 39. The grippable portion 39 is sized and spaced from the body 24 by the web 37 in order to permit several fingers to grip same. The handle portion 36 can be molded as part of the entire assembly or attached by conventional means to the remainder of the assembly 20.

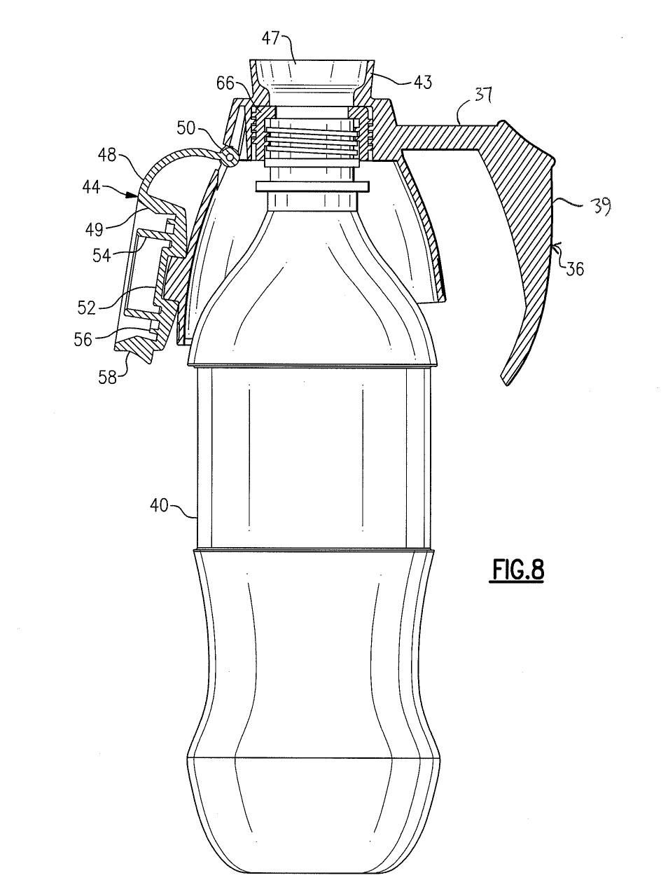

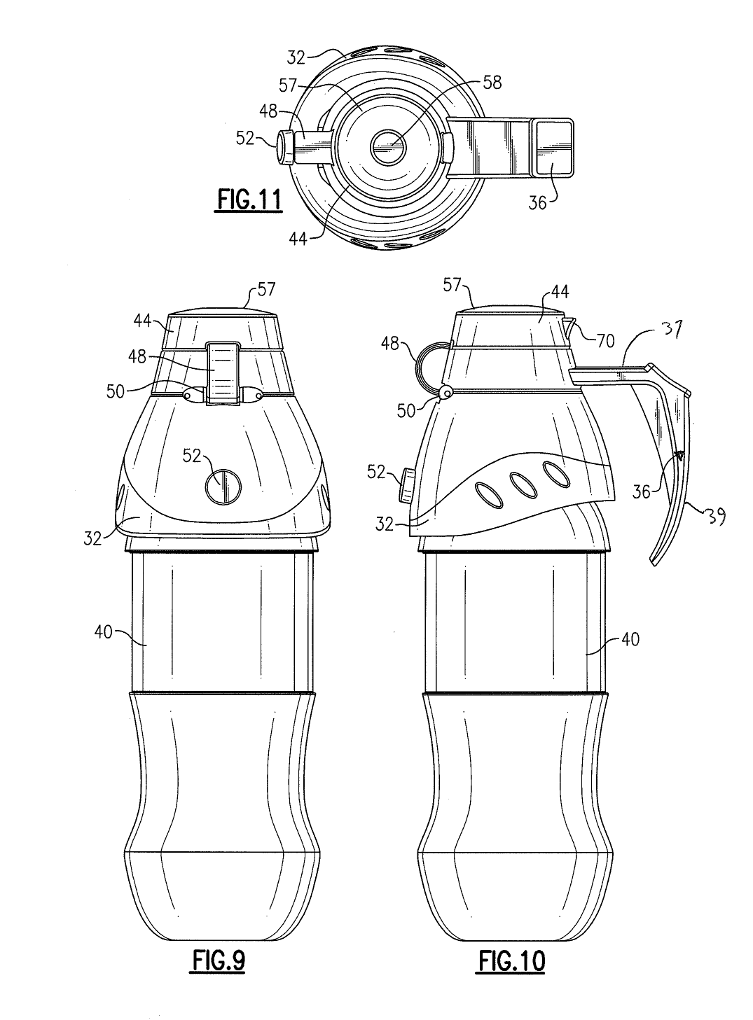

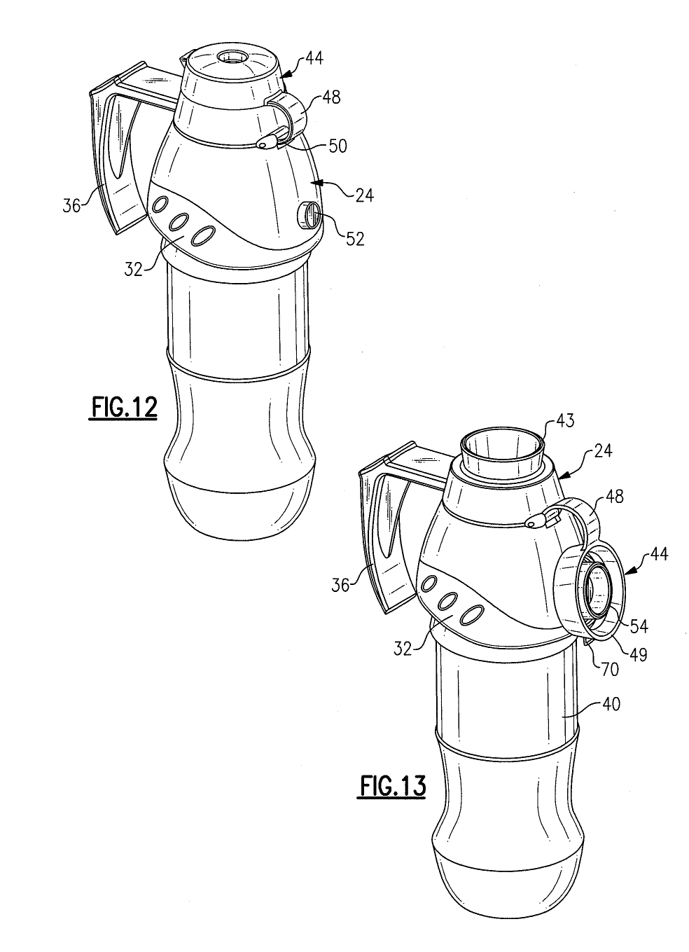

In brief and as shown in FIGS. 4-13, the cap 44 according to this embodiment is designed to be releasably attached to the upper engagement end or spout 43 of the engagement portion 28 of the body 24. According to the present embodiment, the cap 44 is a separate component of the herein described assembly 20 and is also preferably made from a molded plastic material, although other materials could be utilized. The cap 44 is attached by means of a flexible plastic tether 48 to a hinge 50, which according to this specific embodiment includes a hinge pin 51, the hinge being connected by known means to the body 24. The cap 44 according to this exemplary embodiment is defined by a substantially circular configuration and includes a recessed portion formed on an interior surface 56 separating an outer and an inner peripheral ring 49, 54, respectively. The outer peripheral ring 49 is preferably inwardly beveled and is locally deformable, enabling the cap to be attached in snap-fitting relation to the spout 43. The inner peripheral ring 54 is also flexible and is sized to fit within the through opening 47 defined by the annular flange 69 separating the spout 43 and lower engagement end 45.

On an exterior facing surface 57 of the cap 44, a formed recess is formed at substantially the center thereof. According to this embodiment, a plug 52 provided at the front of the body 24 upon the skirting portion 32 permits the cap 44 to be releasably secured thereto when the cap is in an open position, such as shown in FIGS. 8 and 13. Alternatively and in lieu of the plug, a recess or cavity or at least one slot or other retention means can be provided on the front of the herein described assembly 20 or can be otherwise disposed thereupon in order to enable the cap 44 to be secured in a reliable manner while in the open position. Alternatively still, it should be realized that a plug could be provided on the cap for receipt in a cavity provided on the body 24 that would permit a similar snap fitting connection and permit the cap 44 to remain stored while in the open position. As noted, other attachment means can be utilized, such as slots or other means, and that those described are intended only to be exemplary.

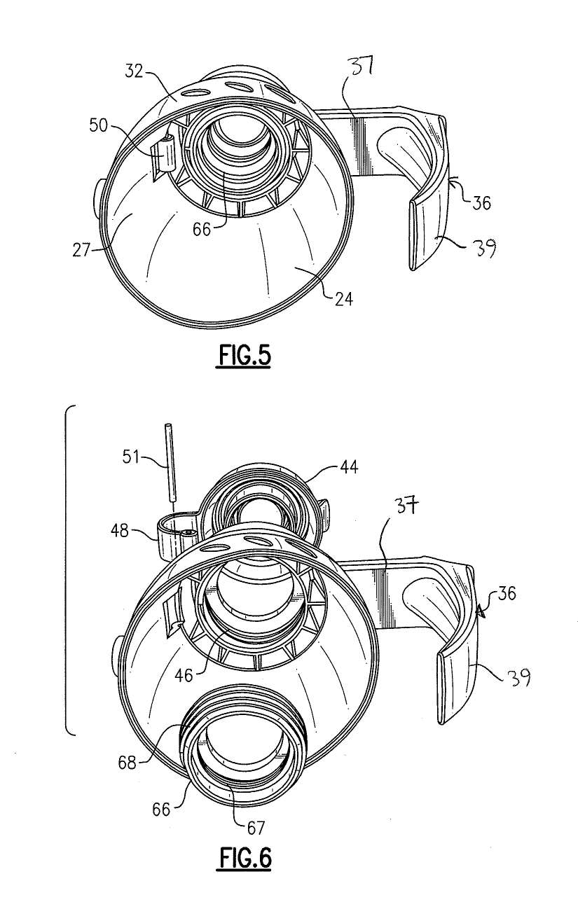

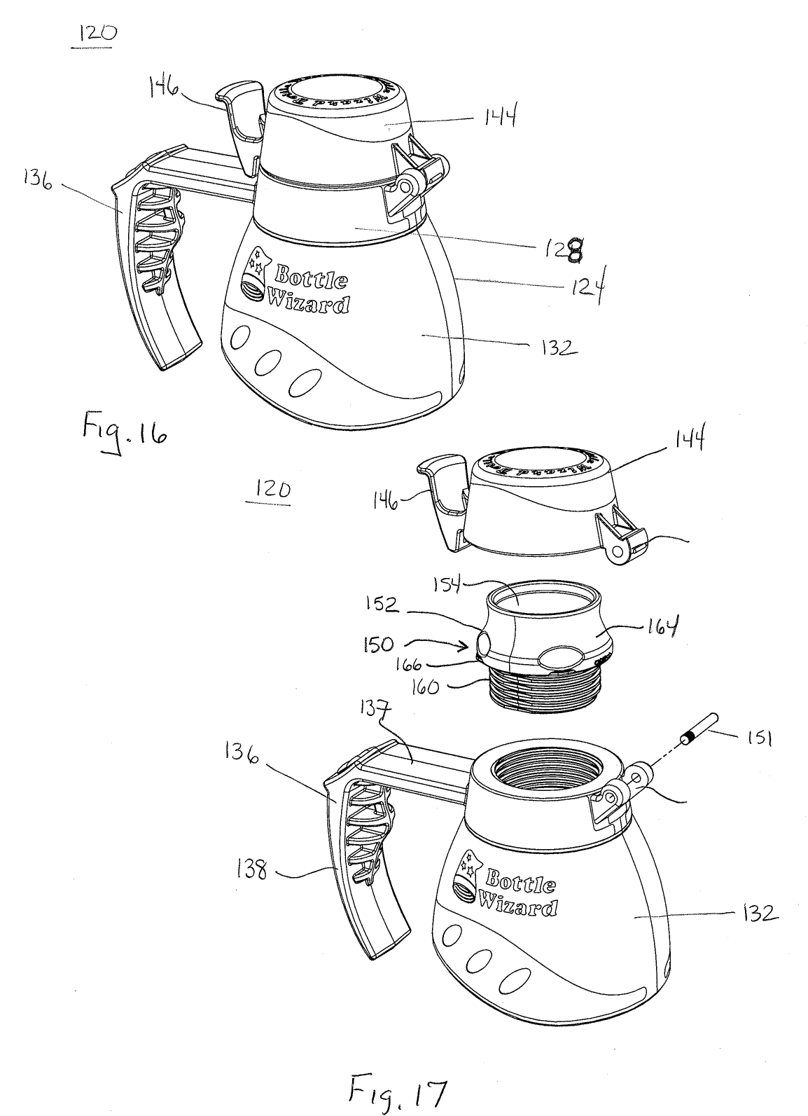

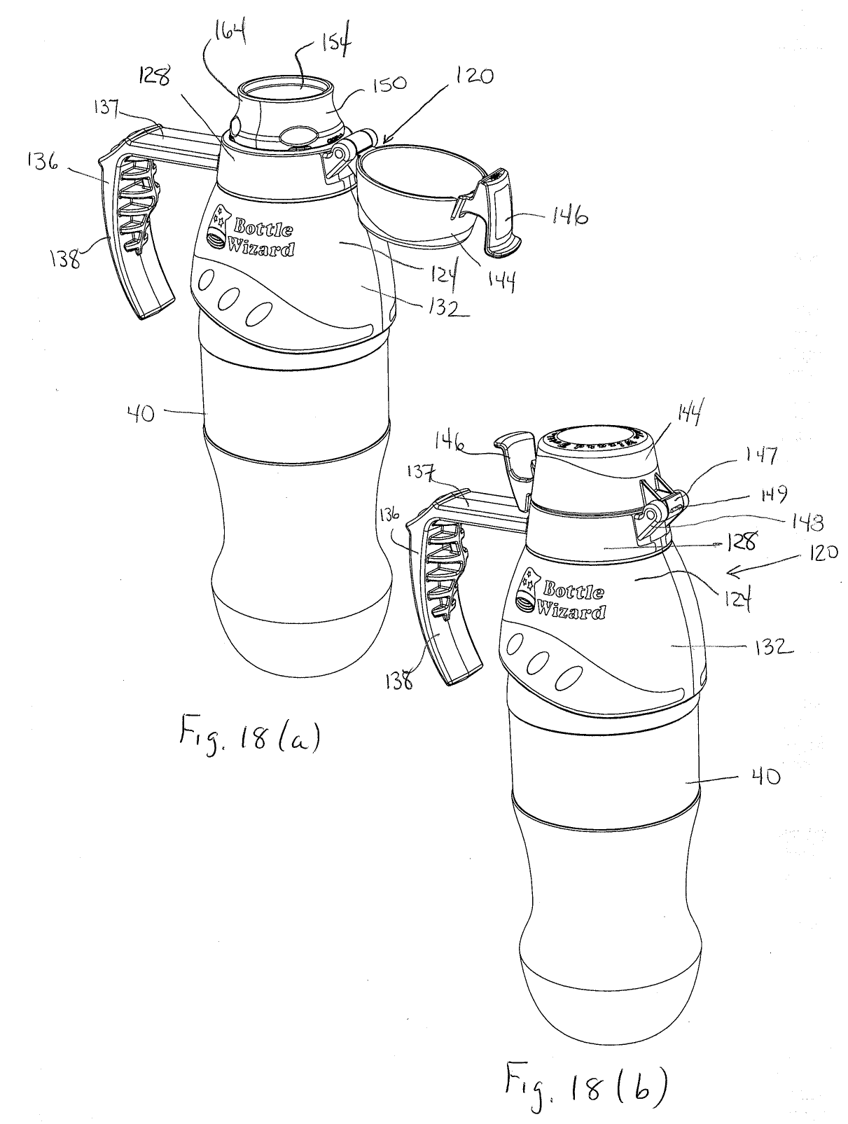

The interior surface of the lower engagement end 45 can be defined, according to one version, with a generic thread 46, FIG. 6, the diameter of the lower engagement end being appropriately sized to enable the assembly 20 to be threadingly engaged and disengaged with the threaded neck 42 of the beverage container 40 according to one embodiment. In accordance with another embodiment, herein shown by way of the exploded assembly views depicted in FIGS. 4, 4(a), and 6, an adapter 66 can be introduced for attachment to the engagement portion 28, whether releasably or by means of a fixed attachment using glue, heat-staking or the like. The adapter 66 according to this version is a substantially cylindrical member that includes a formed set of internal threads 67, FIGS. 4, 6, matching the threaded portion of the neck 42 of the beverage container 40. In this instance, the interior diameter 67 of the adapter 66 must be appropriately sized to engagingly mate with the neck 42 of the beverage container 40 while the interior diameter of the lower engagement end 45 must be appropriately sized to accommodate the threaded exterior surface 69 of the adapter. According to one variation, the interior surface of the lower engagement end 45 includes a set of threads that mate with the external threads 69 of the adapter 66, wherein the interior surface 67 of the adapter can include different threads to enable versatility. An elastomeric O-ring (not shown) can further be included between the adapter 66 and the annular flange 69 to further provide additional leakproofing. According to yet another variation, the adapter 66 can include two different internal threads, a first set of threads that are provided along an axial upper interior portion and a second set of thread provided along a lower interior portion. As such, the adapter 66 can be releasably attached by recognizing the appropriate thread of the bottle 40 and rotating either the upper or lower portions of the adapter into engagement with the threaded neck, to provide additional versatility, the adapter thereby permitting the assembly 20 to accommodate and mate with additional bottle designs. Multiple adapters can be provided with the remaining components of the replaceable bottle cap assembly, each adapter having a common external threaded portion for mating with the body of the assembly 20 and an internal screw thread configured to engage the threaded neck of a beverage container. Other variants are further described in regard to the adapter feature, in the description of FIGS. 15-19.

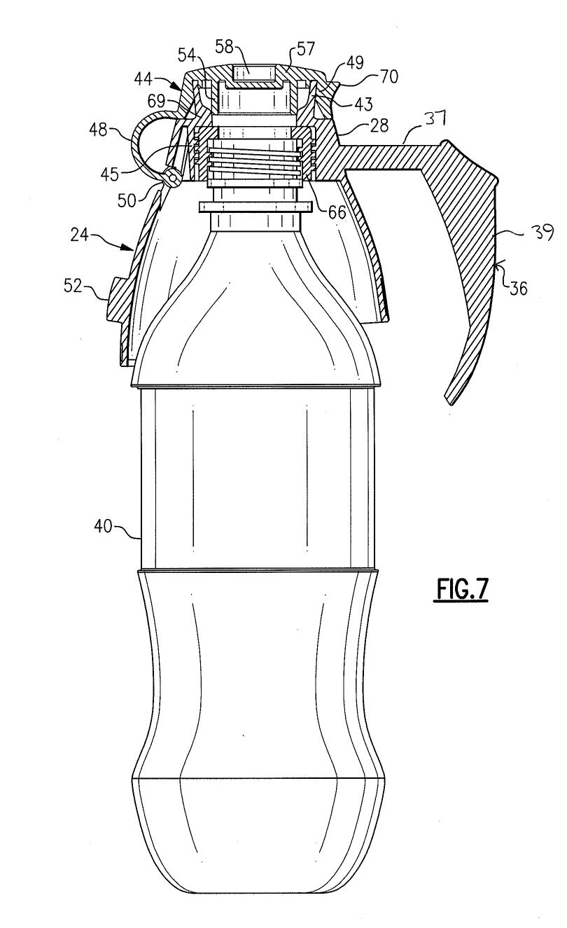

In use and referring to FIGS. 7-13, the threaded cap (not shown) of a beverage container 40 is first twisted off and discarded. The body 24 of the herein described assembly 20 is then attached to the top of the beverage container 40 after the adapter 66 has first been attached to the lower engagement portion of the assembly 20 as shown in FIG. 5, if needed, depending on the bottle. The body 24 is threaded by gripping the bottle 40 and rotating the bottle in a clockwise direction to tighten the assembly 20 in place and in which a lower surface of the annular flange 69 provides a mechanical stop against over rotation. In the assembled condition, the skirting portion 32 is placed into substantial and direct contact with the top of the bottle 40.

In the closed position, the combination of the threaded engagement portion and the cap 44 provides a sufficient and comparable fluidic seal as would be provided by the twist-off cap, if provided alone. In order to access the contents of the bottle 40 and rather then having to untwist the body 24, the cap 44 can be releasably removed from the top of the bottle 40 through its hinged connection by pushing against a front flange 70 of the cap, releasing the cap from the spout 43 of the body 24. Upon opening, the cap 44 can be stored using the plug 52 as attached to the recess 58, also in releasable snap-fitting engagement. In this position, shown in FIGS. 8 and 13, the position of the cap 44 is no longer a concern and does not interfere with the assembly 20. The fluid seal between the threaded neck 42 of the bottle 40 and the interior surfaces of the engagement portion 28 prevent spillage other than through the spout 43 through opening 69 wherein the handle portion 36 is used to lift the assembly 20 and attached beverage container 40. The bottom of the container 40 remains unaffected by way of this attachment and therefore the bottle can be stored in a receptacle (not shown) sized to ordinarily fit the bottle, such as cup or bottle holders typically found in automobiles.

Upon assembly, the skirting portion 32 besides providing an ergonomic advantage further provides a counterbalance to the handle portion 36 so as to prevent an empty or nearly depleted beverage container 40 from tipping and enabling the container and assembly to remain free standing.

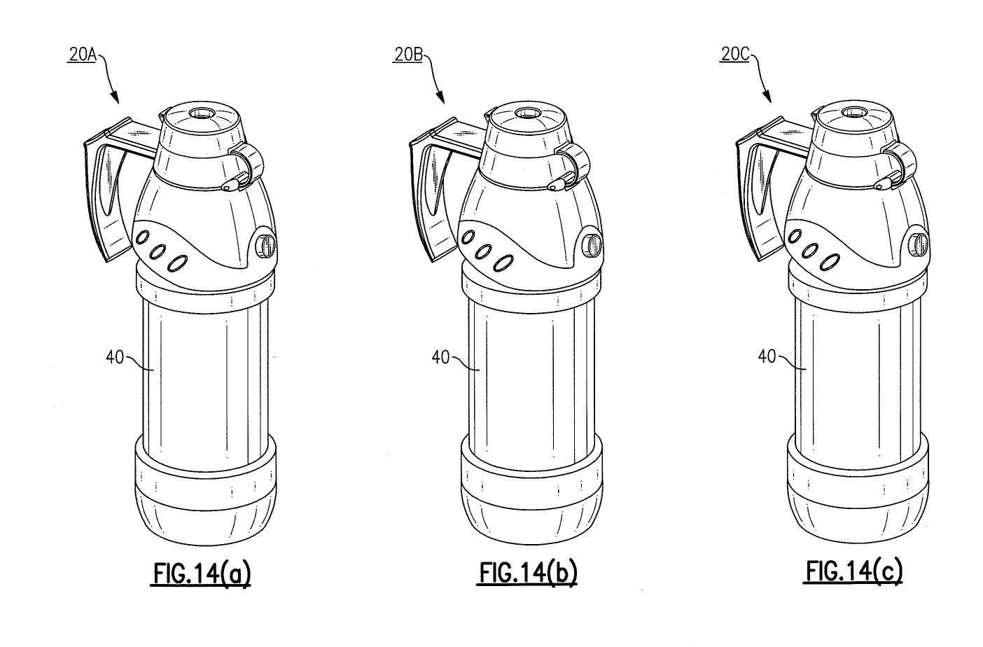

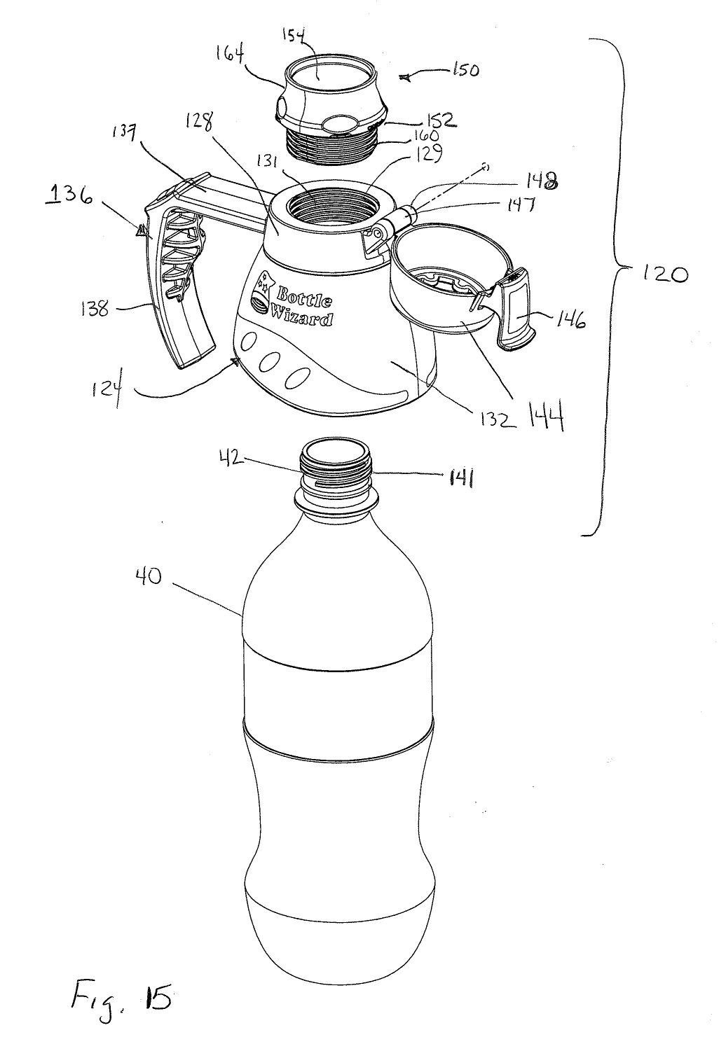

Referring to FIGS. 14(a)-14(c), variations 20(a), 20(b) and 20(c) of the herein described assembly are shown in which the skirting portion and body can be suitably configured and designed for aesthetic and detailing purposes in which varied color schemes of the assembly can be employed. It should be understood that other suitable variations can easily be contemplated.

A second exemplary embodiment of a replaceable bottle cap assembly 120 is herein described with reference to FIGS. 15-19.

The replaceable bottle cap assembly 120 according to this version is defined by a body 124 made from a lightweight durable plastic or other elastomeric material, which is preferably moldable, such as polyethylene, polyamide or other suitable material. The body 124 is defined by a skirting portion 132 at its lower end, the skirting portion having a substantially hemispherical configuration enabling the body 124 to be substantially conformed with the upper end of a beverage container 40, such as a soda bottle. The body 124 is further defined by an interior cavity 127 as well as an engagement section 128 at an opposing upper end, the engagement section defined by a substantially cylindrical portion having a through opening 129 further including a set of internal threads 131. A handle portion 136 extends outwardly from one side of the exterior of the body 124, the handle portion including a laterally extending section 137 and an inwardly curved gripping portion 138 that extends downwardly from the outer end of the laterally extending portion wherein the curved portion is disposed a sufficient distance from the body to enable the passage of fingers of a user and enabling gripping thereof. The beverage container 40, which in this instance is a soda bottle, includes an upper necked portion 42, which includes a set of external threads 141. For purposes of this disclosure, it is assumed that different beverage containers, such as those commercially bottled by Pepsi Cola and Coca Cola, by way of example, include necked portions that are defined by specifically different thread patterns.

A cap 144 is hingably attached to the body 124 and more specifically to the exterior of the engagement section 128 wherein the cap can be selectively opened and closed using a gripping tab 146 which is provided on one side of the cap. A hinge assembly provided oppositely from the gripping tab 146 includes a hinge portion 147 extending oppositely from the gripping tab that is fitted within a hinge bracket 148 extending from the body 124. A hinge pin 151 is added through aligned openings formed in the hinge portion 147 and bracket 148, respectively. According to this embodiment, the hinge assembly is configured to enable the cap 144 to be retained in an open position, such as that shown in FIG. 18(a) while the assembly is being used, wherein the hinge portion 147 includes a detent 149, FIG. 18(b) that provides an over center positioning of the cap 144 relative to a hinge axis defined by the hinge pin 151.

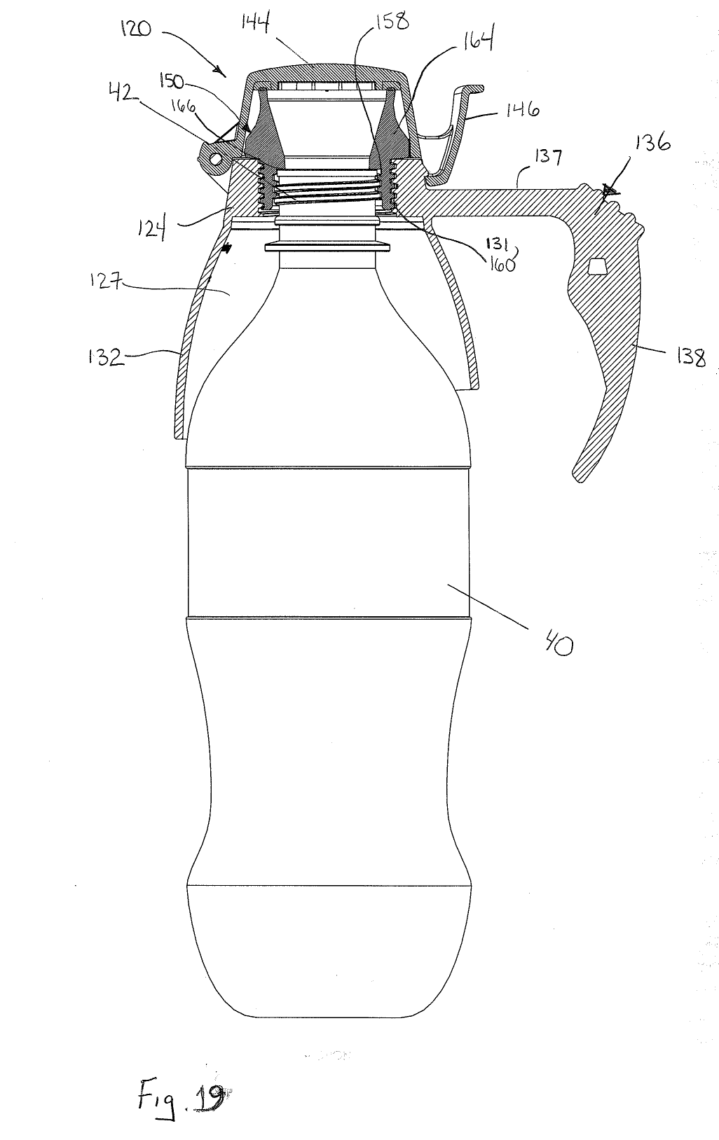

According to this embodiment, an adapter 150 is releasably attached to the engagement section 128 of the body 124, the adapter being defined by a substantially cylindrical member 152 having a through opening 154. A lower portion of the opening 154 is defined by a set of internal threads 158, these threads being matched to the threads 141 of the necked portion 42 of the beverage container 40. The adapter 150 further is defined by a set of formed external threads 160 on a lower end that match the interior threads of the engagement section 128 of the body 124, as clearly shown in the sectioned view of FIG. 19. The lower end of the adapter 150 is sized to be threadingly fitted within the engagement section 128 of the body 124 through the opening, the adapter being further defined by an upper drinking spout section 164 which has a larger exterior diameter than the opening such that an annular shoulder 166 forming the bottom surface of the drinking spout section engages the top surface of the body 124 when fully engaged. According to this embodiment, the external threads 160 of the adapter 150 and the internal threads 131 of the engagement section 128 of the body 124 are reverse threads, meaning that the threads used to engage the beverage container 40 are engaged conventionally (i.e., in a clockwise direction to tighten) while the threads used to secure the adapter 150 to the body 124 are engaged oppositely to prevent loosening during use of this assembly 120. For purposes of this exemplary embodiment and for purposes of description, a single adapter is depicted. However, the herein described cap assembly can be provided with multiple alternative adapters, each of the adapters commonly including an external thread that enables attachment to the engagement section 128 of the body 124 and wherein each adapter includes a set of internal threads matching those of specific beverage containers.

The extending spout section of the adapter 150, when assembled to the body 124, is sized to fit within the defined hollow cavity of the cap 144, such as shown in FIG. 18(a). Referring to FIGS. 15-19 and in use, an adapter 150 is selected for use with the beverage container 40. Initially, the adapter 150 can first be threadingly engaged with the neck portion 42 of the beverage container 40 to insure the proper adapter is used. Assuming the correct adapter is selected, the adapter 150 is threadingly engaged with the engagement section 128 of the body 124 and tightened in place. As noted and according to this embodiment, the threads of this connection are reverse threads, meaning that the adapter 150 is rotated counterclockwise to secure same within the body 124. The cap assembly 120 can then be attached to the beverage container 40 by engaging the internal threads of the adapter 150 with those of the necked portion 42 of the beverage container 40 until tightened. The foregoing produces a substantially sealed connection in which the annular shoulder 166 is seated against the top surface of the beverage container 40. The cap 144 can then be closed wherein the lower end of the gripping tab 146 can be secured to an annular lip 170 of the engagement section 128 of the body 124, as shown in FIG. 19.

When accessing the contents of the beverage container 40, the gripping tab 146 of the cap 144 is pulled upwardly releasing the tab from the annular lip 170 of the engagement section 128 and allowing the cap to be hingably opened. The detent 149 in the hinge assembly enables the cap 144 to remain in an open position, FIG. 18(a), with the user being able to lift the container and the assembly using the handle portion 136 with the drinking spout section being exposed to access the contents of the beverage container 40. As shown in FIG. 19, the handle portion 136 of the herein described assembly 120 is configured to enable the user (not shown) to pick up the cap assembly 120 when attached to the beverage container 40 with one hand and also without having to place either hand on the exterior of the container. As such, there is no appreciable heat transfer meaning that a contained beverage may remain cold for a longer period of time.

### Parts List for FIGS. 1-19

20 replaceable bottle cap assembly
24 body
25 open lower opening
27 interior cavity
28 engagement portion
31 threaded portion
32 skirting portion
36 handle portion
37 web
39 vertically extending gripping portion
30 beverage container (bottle)
42 threaded neck or upper necked portion
43 upper engagement end or spout
44 cap
45 lower engagement end
46 thread, lower engagement end
47 through opening
48 tether
49 outer peripheral ring
50 hinge
51 hinge pin
52 plug
54 inner peripheral ring
56 interior surface, cap
57 exterior surface, cap
58 recess
66 adapter
67 interior thread, adapter
68 exterior thread, adapter
69 annular flange
70 front flange
120 replaceable bottle cap assembly
124 body
127 interior cavity
128 engagement section
129 through opening
131 internal threads
132 skirting portion
136 handle portion
137 horizontal extending portion
138 curved gripping portion
144 cap
146 gripping tab
147 hinge portion
148 hinge bracket
149 detent
150 adapter
151 hinge pin
152 cylindrical member
154 through opening
158 internal threads, adapter
160 external threads, adapter
164 upper drinking spout section
166 annular shoulder
170 annular lip

It will be readily apparent that numerous variations and modifications are possible within the intended ambits of this disclosure, including those that are defined by the following claims:

1. A replaceable bottle cap assembly for use with a threaded beverage container, said cap assembly comprising:
a body shaped to substantially conform with the top of a beverage container, the body having a threaded portion;
at least one adapter having a first threaded portion adapted for engaging the threaded neck of a beverage container and a second threaded portion that is releasably attachable to the threaded portion of said body, said at least one adapter including a spout portion; and
a snap-fitting cap attached to said body, the cap being releasably attachable to the body to expose said spout portion and in order to selectively access the contents of a beverage container to which the cap assembly is attached.

2. The replaceable cap assembly as recited in claim 1, wherein said body includes a skirting portion that is shaped to conform with a curved top of a beverage container.

3. The replaceable cap assembly as recited in claim 1, including retaining means for retaining said cap when said cap is in an open position.

4. The replaceable cap assembly as recited in claim 3, including a hinge assembly for hingably attaching said cap to said body, said hinge assembly including a hinge bracket formed on said body that receives a hinge portion of said cap and having a hinge pin extending therethrough and in which said retaining means includes a detent for engaging said body when said cap is in said open position.

5. The replaceable cap assembly as recited in claim 1, wherein at least a portion of said body is made from a soft grippable material.

6. The assembly as recited in claim 2, wherein at least a portion of said skirting portion is made from a soft grippable material.

7. The replaceable cap assembly as recited in claim 1, including a handle portion enabling a beverage container to which said assembly is attached to be picked up by a user without contacting said beverage container.

8. The replaceable cap assembly as recited in claim 7, wherein said handle portion is integral to said body.

9. The replaceable cap assembly as recited in claim 1, including an engagement section formed in an upper portion of said body, said engagement portion including said threaded portion for receiving said adapter.

10. The replaceable cap assembly as recited in claim 9, wherein said spout portion of said adapter includes a bottom surface that engages the top surface of a beverage container when said adapter is fully engaged therewith.

11. A method for manufacturing a replaceable cap assembly adapted for use with at least two beverage containers having different threaded necked portions, said method comprising the steps of:
providing a set of adapters, each adapter having a different interior threaded engagement portion that can be releasably attached to the threaded neck of a different beverage container;
providing a body, said body including a through opening including an engagement portion for releasably and interchangeably receiving each of said adapters wherein said adapter includes an exterior threaded portion for engaging an interior threaded portion of said body to releasably retain a said adapter; and
providing a releasable snap-fitting cap for selectively covering said through opening, thereby enabling the contents of a beverage container to be accessed for consumption.

12. A method as recited in claim 11, including the step of providing means for retaining said snap-fitting cap on said body when said cap is not covering said threaded portion.

13. A method as recited in claim 11, including the step of providing a handle portion in relation to said body to enable said assembly and an attached beverage container to be lifted.

14. A method of using a releasable cap assembly for a beverage container, said beverage container including a threaded neck portion that receives a cap replaced by said assembly, said method comprising the steps of:
attaching an adapter to the necked threaded portion of a beverage container, said adapter having a through opening having an internal thread over a portion thereof that corresponds to a set of external necked threads of said beverage container, said adapter further including an external threaded portion;
providing a body that conforms to a curved top of said beverage container, said body including a through opening having an internal threaded section and a handle portion; and
attaching the external threads of said adapter to the internal threads of said body such that a portion of said adapter extends outwardly from said opening and forms a spout.

15. A method as recited in claim 14, including the step of opening a cap hingably attached to said body to access the contents of said beverage container when said cap after said assembly has been attached thereto.

16. A method as recited in claim 14, wherein said body includes an upper engagement portion having said internal threaded section and in which said adapter further includes a spout that extends above said body when said adapter is attached thereto.

17. A method as recited in claim 14, including a first adapter that includes an internal thread configured to engage a first beverage container and a second adapter that is configured to threadingly engage a second beverage container in which each of the internal threads are different, said method including the additional steps of selecting an adapter based on the beverage container to which the assembly is to be attached.
